(19) United States
(12) Patent Application Publication
(10) Pub. No.: US 2010/0265308 A1
(43) Pub. Date: Oct. 21, 2010

(54) Suction Device for Sucking a Print Medium in a Large Inkjet Printer

(76) Inventors: Hsien-Chang Lin, Hsi Chih City (TW); Hui-Te Yu, Hsi Chih City (TW)

Correspondence Address: Muncy, Geissler, Olds & Lowe, PLLC, 4000 Legato Road, Suite 310, FAIRFAX, VA, 22033, US

(21) Appl. No.: 12/176,354

(22) Filed: Jul. 19, 2008

(51) Int. Cl. B41J 2/01

(52) U.S. Cl. 347/104

(57) ABSTRACT

A suction device for sucking a print medium in a large inkjet printer is disclosed. The suction device is disposed on a suction conveying platen of the large inkjet printer, wherein the print medium is conveyed on the suction conveying platen for being printed by a printing module. The suction device comprises at least one suction member disposed on the top surface of the suction conveying platen for supporting the print medium. The suction member including a sucking portion, a non-sucking portion located alongside the sucking portion, and a plurality of orifices formed in the sucking portion.

### FIELD OF THE INVENTION

The present invention relates to a suction device for sucking a print medium in a large inkjet printer, and particularly to a suction member for flattening the edge portion of a print medium thereon by adjusting the range of suction portion to prevent the edge portion of the print medium from lifting up and improve the printing quality.

### BACKGROUND OF THE INVENTION

Printers have become one of the essential equipment of the peripheral devices of the computer or printing industry. Inkjet printers have made rapid technological advances in recent years, and the development of superior multi-color inkjet printers capable of photographic-quality output has done much to help them retain their advantage in the realm of color.

In the printing industry, large inkjet printers are well developed and known that the ejected inks under a fast curing process would appear highly desirable and afford a tough, durable image upon print media to which they are applied. This makes the large inkjet printers especially applicable to printing on various print media with different properties or thickness such as plastics packaging, conventional cellulosic substrates and synthetic polymeric substrates. Thus, large inkjet printers can make images more easily, more quickly and more inexpensively than the gravure printing system with a pre-processing taking much cost and times. In the conventional large inkjet printer, a print medium receiving the printed image rests on a horizontally extending conveying platen, which is situated below a movable carriage carrying a printing module. To flatten the print medium on the conveying platen for ensuring the printing quality, a suction fan is disposed under the platen and a plurality of holes are formed in a contact surface of the platen capable of generating suction through the holes, and thereby bring the print medium into close contact with the surface of the platen.

However, the holes formed in the conveying platen are arranged on the entire surface of the conveying platen in a uniform pattern such that the size of the suction area of the platen is different from the dimension of the print medium. There has been a problem of the edge portion of a thin print lo medium that the edge portion may lift up in the beginning of printing operation, shorten the distance of the printing module to the print media and affect the emitting precision of ink droplets to the print media. Also, a leading edge of the print medium may bump into print heads of the printing module and interfere with the printing operation.

### SUMMARY OF THE INVENTION

The primary object of the present invention is to provide a suction device for sucking a print medium in a large inkjet printer as to prevent the edge portion of a print medium from lifting up to thereby improve the printing efficiency and quality.

In order to achieve the aforementioned object, the suction device for sucking a print medium in a large inkjet printer is disposed on a suction conveying platen of the large inkjet printer, wherein the print medium is conveyed on the suction conveying platen for being printed by a printing module. The suction device comprises at least one suction member disposed on the top surface of the suction conveying platen for supporting the print medium. The suction member including a sucking portion, a non-sucking portion located alongside the sucking portion, and a plurality of orifices formed in the sucking portion.

The present invention will be apparent after reading the detailed description of the preferred embodiments in reference to the accompanying drawings.

### BRIEF DESCRIPTION OF THE DRAWINGS

FIG. 1 is a perspective view of the first embodiment showing a suction device for sucking a print medium in a large inkjet printer according to the present invention;

FIG. 2 is a perspective view schematically showing a suction device disposed on the suction conveying platen according to the first embodiment of the present invention;

FIG. 3 is a perspective view schematically showing a print medium disposed on the sucking portion suction device;

FIG. 4 is a perspective view of another embodiment schematically showing a suction member with two loop belts formed by interlacing and superimposing each other;

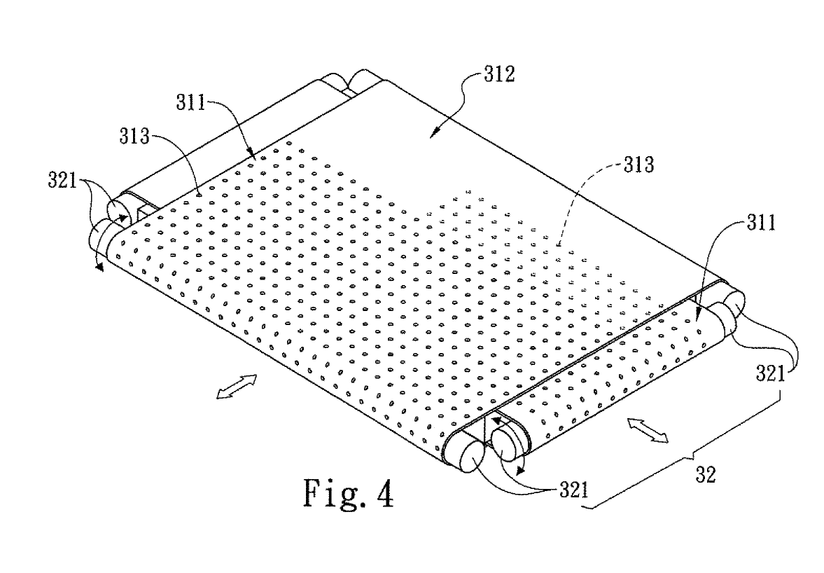

FIG. 5 is a perspective view of another embodiment schematically showing a print medium disposed on the suction member in the printing operation.

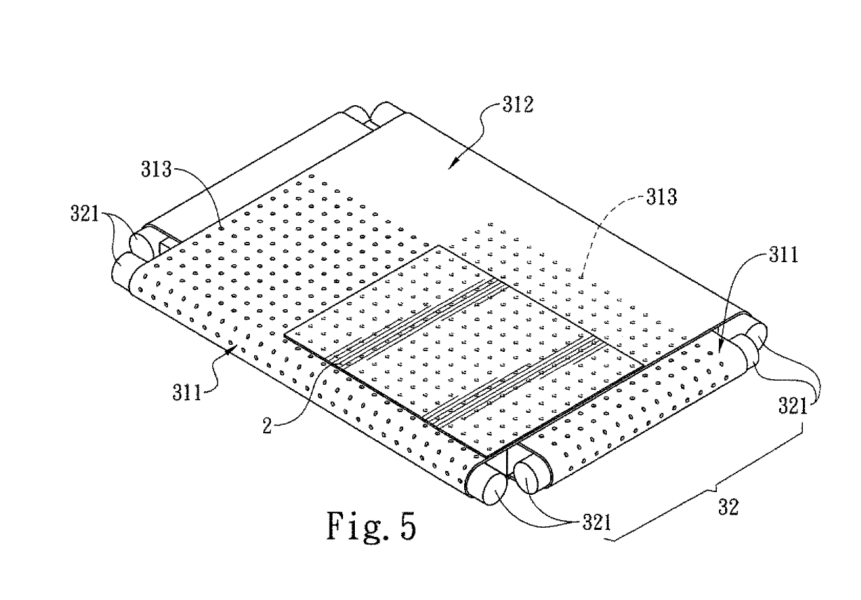

### DETAILED DESCRIPTION OF THE PREFERRED EMBODIMENT

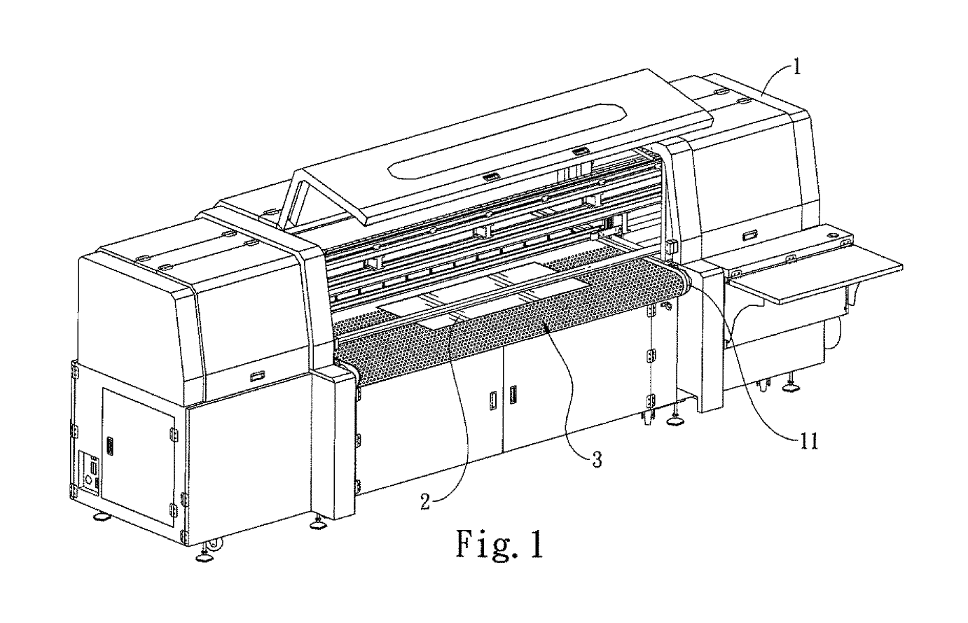

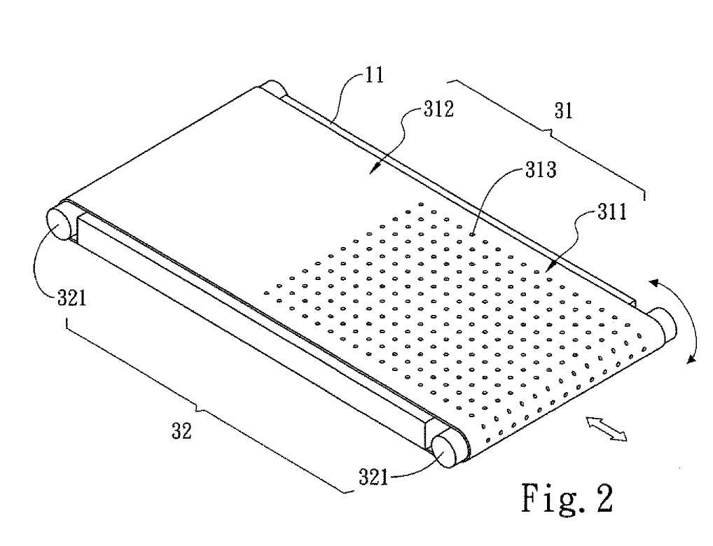

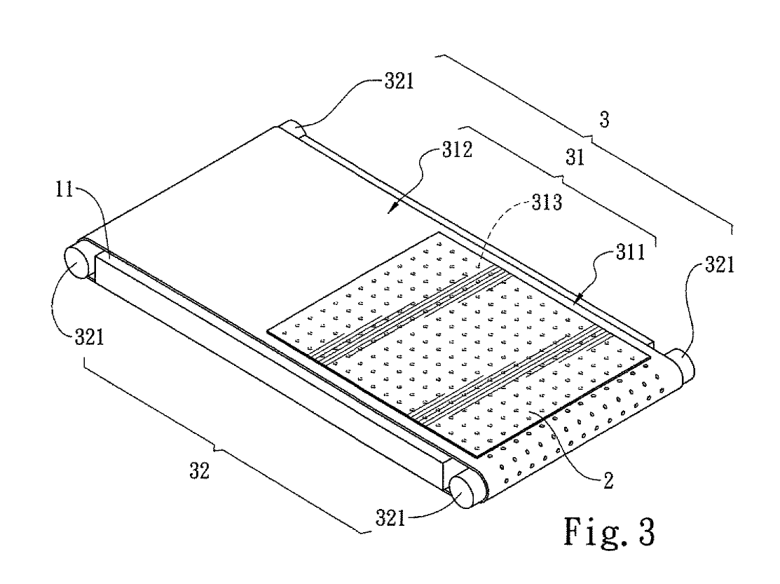

Referring to FIG. 1-3, there is illustrated an embodiment of a suction device 3 for sucking a print medium 2 in a large inkjet printer 1, wherein the suction device 3 is disposed on a suction conveying platen 11 of the large inkjet printer 1, and the print medium 2 is conveyed on the suction conveying platen 11 for being printed by a printing module.

The suction device 3 comprises at least one suction member 31 in a form of a loop belt or a thin metal board. The suction member 31 is disposed on the top surface of the suction conveying platen 11 for supporting the print medium 2, and a sucking portion 311 and a non-sucking portion 312 are disposed in the suction member 31. The non-sucking portion 312 is located alongside the sucking portion 311, and a plurality of orifices 313 are formed in the sucking portion 311.

Further, the suction device 3 comprises a rotating unit 32 connecting to both sides of the suction member 31. The rotating unit 32 comprises two fixing roller 321 being respectively disposed at both sides of the suction member 31 for rotating the suction member 31, so as to adjust the range of the sucking portion 311 and the non-sucking portion 312.

In practice, the range of the sucking portion 311 and the non-sucking portion 312 can be adjusted after the print medium 2 is disposed on the suction member 31 by a user, and thereby to align the edge of the print medium 2 on the edge of the sucking portion 311 to enhance the attachment of the edge of the print medium to the suction member 31. Therefore, the suction member 31 can prevent the edge portion of the print medium 2 from lifting up so as to flatten the print medium 2 on the conveying platen 11 for ensuring the printing quality in printing operation.

In another embodiment, the suction member 31 has two loop belts formed by interlacing and superimposing each other, such that a print medium in a shape of rectangle can be flattened by the suction member 31. Each loop belt has a sucking portion 311 and a non-sucking portion 312, and a rotating unit is disposed at both side of each loop belt for variably changing the range of the sucking portion 311 and the non-sucking portion 312. Depending on the application, the four sides of a rectangle print medium 2 can be flattened by the suction member 31 to ensure the printing quality in printing operation.

As stated in the above disclosed, the present invention can surely achieve its expected objects to provide spacing-sensing apparatus for use in a printing module of printer to send out a signal for stopping the descending of print module when the printing module descends to a predetermined distance from the printing module to the print media.

It should be understood that different modifications and variations could be made from the disclosures of the present invention by the people familiar in the art without departing the spirit of the present invention.

What is claimed is:

1. A suction device for sucking a print medium in a large inkjet printer, wherein the suction device is disposed on a suction conveying platen of the large inkjet printer, and the print medium is conveyed on the suction conveying platen for being printed by a printing module, the suction device comprises:
At least one suction member disposed on the top surface of the suction conveying platen for supporting the print medium, the suction member including a sucking portion, a non-sucking portion located alongside the sucking portion, and a plurality of orifices formed in the sucking portion.

2. The suction device as claimed in claim 1, wherein the suction member is a loop belt.

3. The suction device as claimed in claim 1, further comprising a rotating unit connecting to both sides of the suction member for adjusting the range of the sucking portion and the non-sucking portion.

4. The suction device as claimed in claim 2, further comprising a rotating unit connecting to both sides of the suction member for adjusting the range of the sucking portion and the non-sucking portion.

5. The suction device as claimed in claim 3, wherein the rotating unit comprises two fixing roller being respectively disposed at both sides of the suction member for rotating the suction member to adjust the range of the sucking portion and the non-sucking portion.

6. The suction device as claimed in claim 1, wherein the suction member has two loop belts formed by interlacing and superimposing each other, and each loop belt has a sucking portion and a non-sucking portion, and a rotating unit is disposed at both side of each loop belt for variably changing the range of the sucking portion and the non-sucking portion.

7. The suction device as claimed in claim 6, wherein the rotating direction of one loop belt is transverse to the rotating direction of the other loop belt.

8. The suction device as claimed in claim 6, wherein the rotating unit includes two fixing rollers disposed at both sides of the suction member for rotating the suction member to adjust the range of the sucking portion and the non-sucking portion.

9. The suction device as claimed in claim 1, wherein the suction member is a board member.

10. The suction device as claimed in claim 9, wherein the suction member is a thin metal board.
